(19) United States
(12) Patent Application Publication
(10) Pub. No.: US 2014/0166307 A1
(43) Pub. Date: Jun. 19, 2014

(54) SELF CLAMPING SHAKER SCREENS

(71) Applicant: Eric Cady, Florence, KY (US)

(72) Inventor: Eric Cady, Florence, KY (US)

(73) Assignee: M-I L.L.C., Houston, TX (US)

(21) Appl. No.: 14/125,005

(22) PCT Filed: Jun. 8, 2012
(86) PCT No.: PCT/US2012/041481

§ 371 Date: Mar. 10, 2014

Related U.S. Application Data
(60) Provisional application No. 61/495,195, filed on Jun. 9, 2011.

(51) Int. Cl. E21B 21/06; B07B 1/46

(52) U.S. Cl. CPC E21B 21/065; B07B 1/46
USPC 166/378; 166/227; 166/230

(57) ABSTRACT

A screen frame assembly, including a frame having a first end, a second end, a top surface, a first side disposed between the first end and the second end, and a second side disposed opposite the first side and disposed between the first end and the second end, in which at least one of the first end and the second end is sloped.

### BACKGROUND

Oilfield drilling fluid, often called “mud,” serves multiple purposes in the industry. Among its many functions, the drilling mud acts as a lubricant to cool rotary drill bits and facilitate faster cutting rates. The mud is mixed at the surface and pumped downhole through a bore of the drillstring to the drill bit where it exits through various nozzles and ports, lubricating and cooling the drill bit. After exiting through the nozzles, the “spent” fluid returns to the surface through an annulus formed between the drillstring and the drilled wellbore.

Furthermore, drilling mud provides a column of hydrostatic pressure, or head, to prevent “blow out” of the well being drilled. This hydrostatic pressure offsets formation pressures thereby preventing fluids from blowing out if pressurized deposits in the formation are breeched. Two factors contributing to the hydrostatic pressure of the drilling mud column are the height (or depth) of the column (i.e., the vertical distance from the surface to the bottom of the wellbore) and the density (or its inverse, specific gravity) of the fluid used. Various weighting and lubrication agents are mixed into the drilling mud to obtain the right mixture for the type and construction of the formation to be drilled. Increasing the amount of weighting agent solute dissolved in the mud base will generally create a heavier drilling mud. Drilling mud that is too light may not protect the formation from blow outs, and drilling mud that is too heavy may over invade the formation. Therefore, much time and consideration is spent to ensure the mud mixture is optimal. Because the mud evaluation and mixture process is time consuming and expensive, drillers and service companies prefer to reclaim the returned drilling mud and recycle it for continued use.

Another purpose of the drilling mud is to carry the cuttings away from the drill bit to the surface. As a drill bit pulverizes or scrapes the rock formation at the bottom of the borehole, small pieces of solid material are left behind. The drilling fluid exiting the nozzles at the bit stir up and carry the solid particles of rock and formation to the surface within the annulus between the drillstring and the borehole. Therefore, the fluid exiting the borehole from the annulus is a slurry of formation cuttings in drilling mud, and the cutting particulates must be removed before the mud can be recycled.

One type of apparatus used to remove cuttings and other solid particulates from drilling mud is commonly referred to in the industry as a “shale shaker.” A shale shaker, also known as a vibratory separator, is a vibrating sieve-like table upon which returning used drilling mud is deposited and through which substantially cleaner drilling mud emerges. Returning drilling mud is deposited on the shale shaker. As the drilling mud travels across the shaker, the fluid falls through the perforations to a reservoir below thereby leaving the solid particulate material behind.

Screens used with shale shakers may be emplaced in a generally horizontal fashion on a generally horizontal bed or support within a basket in the shaker. The screens themselves may be flat or nearly flat, corrugated, depressed, or contain raised surfaces. The basket in which the screens are mounted may be inclined towards a discharge end of the shale shaker. The amount of vibration and an angle of inclination of the shale shaker table may be adjustable to accommodate various drilling mud flow rates and particulate percentages in the drilling mud. After the fluid passes through the perforated bottom of the shale shaker, it may either return to service in the borehole immediately, be stored for measurement and evaluation, or pass through an additional piece of equipment (e.g., a drying shaker, a centrifuge, or a smaller sized shale shaker) to remove smaller cuttings and/or particulate matter. The shale shaker imparts a rapidly reciprocating motion to the basket and, hence, the screens. Material from which particles are to be separated is poured onto a back end of the vibrating screen, flowing toward the discharge end of the basket. Large particles that are unable to move through the screen remain on top of the screen and move toward the discharge end of the basket where they are collected. The smaller particles and fluid flow through the screen and collect in a bed, receptacle, or pan beneath the screen.

In some shale shakers a fine screen cloth is used with the vibrating screen. The screen may have two or more overlaying layers of screen cloth or mesh. Layers of cloth or mesh may be bonded together and placed over a support, supports, or a perforated or apertured plate. The frame of the vibrating screen is resiliently suspended or mounted upon a support and is caused to vibrate by a vibrating mechanism (e.g., an unbalanced weight on a rotating shaft connected to the frame). Each screen may be vibrated by vibratory equipment to create a flow of trapped solids on top surfaces of the screen for removal and disposal of solids. The fineness or coarseness of the mesh of a screen may vary depending upon mud flow rate and the size of the solids to be removed.

While there are numerous styles and sizes of filter screens, they generally follow similar design. Filter screens include a perforated plate base upon which a wire mesh, or other perforated filter overlay, is positioned. The perforated plate base generally provides structural support and allows the passage of fluids therethrough, while the wire mesh overlay defines the largest solid particle capable of passing therethrough. While many perforated plate bases are generally flat or slightly curved in shape, it should be understood that perforated plate bases having a plurality of corrugated or pyramid-shaped channels extending thereacross may be used instead. In theory, the pyramid-shaped channels provide additional surface area for the fluid-solid separation process to take place, and act to guide solids along their length toward the end of the shale shaker from where they are disposed.

FIG. 1 illustrates conventional attachment of a screen to a shale shaker 2. One or more shaker screens 4 may be installed in, or secured to, the shale shaker 2 with a wedge block 6. The screen 4 is placed on a support rail (not shown) and positioned underneath a stationary wedge guide 8. The wedge block 6 is then pounded into position so as to secure the screen 4 to the shaker separator 2. One of ordinary skill in the art will appreciate that the operator often chooses to use a combination of a hammer and a suitable piece of wood in contact with the wedge block 6 to deliver sufficient force to fully tighten the wedge block 6. As shown in FIG. 1, the wedge block 6 may also include a hammer surface 10 to aid in installation (as by pounding on surface 10a) and removal (as by pounding on surface 10b). Some prior art shale shakers have a hole-and-pin system to secure the position of the shaker screen 4 on the sealing surface of the shale shaker 2 during installation of the shaker screen 4 and tightening of the wedge block 6.

The filter screens used in shale shakers, through which the solids are separated from the drilling mud, wear out over time due to vibration and need replacement. Because shale shakers may be in continuous use, it is beneficial to minimize repair operations and their associated downtimes.

Accordingly, there exists a need for a shaker apparatus that will efficiently seal between screens, filter particular matter, and reduce the downtime required to change screens.

### SUMMARY

According to one aspect of the present disclosure, there is provided a screen frame assembly, including a frame having a first end, a second end, a top surface, a first side disposed between the first end and the second end, and a second side disposed opposite the first side and disposed between the first end and the second end, in which at least one of the first end and the second end is sloped.

According to another aspect of the present disclosure, there is provided a method of assembling a shaker apparatus, including providing a basket having a feed end, a discharge end, and two side tracks, inserting a first screen frame assembly into the two side tracks of the basket, the first screen frame assembly having a first end, a second end, a top surface, a first side disposed between the first end and the second end, and a second side disposed opposite the first side and disposed between the first end and the second end, in which at least one of the first end and the second end is sloped, inserting a second screen frame assembly into the two side tracks of the basket, the second screen frame assembly having a first end, a second end, a top surface, a first side disposed between the first end and the second end, and a second side disposed opposite the first side and disposed between the first end and the second end, in which at least one of the first end and the second end is sloped, and engaging the sloped ends of each of the first screen frame assembly and the second screen frame assembly.

Other aspects and advantages will be apparent from the following description and the appended claims.

### BRIEF DESCRIPTION OF DRAWINGS

FIG. 1 is a schematic drawing of conventional means of attaching a screen assembly to a shale shaker.

FIG. 2 is a schematic drawing of a screen frame assembly in accordance with embodiments disclosed herein.

FIGS. 3A and 3B are schematic drawings of a profile of a screen frame assembly according to embodiments disclosed herein.

FIG. 4A-4E are perspective views of a shaker apparatus according to embodiments disclosed herein.

FIG. 5 is a side view of multiple screen frame assemblies according to embodiments disclosed herein.

FIG. 6 is a side view of a shaker apparatus in accordance with embodiments disclosed herein.

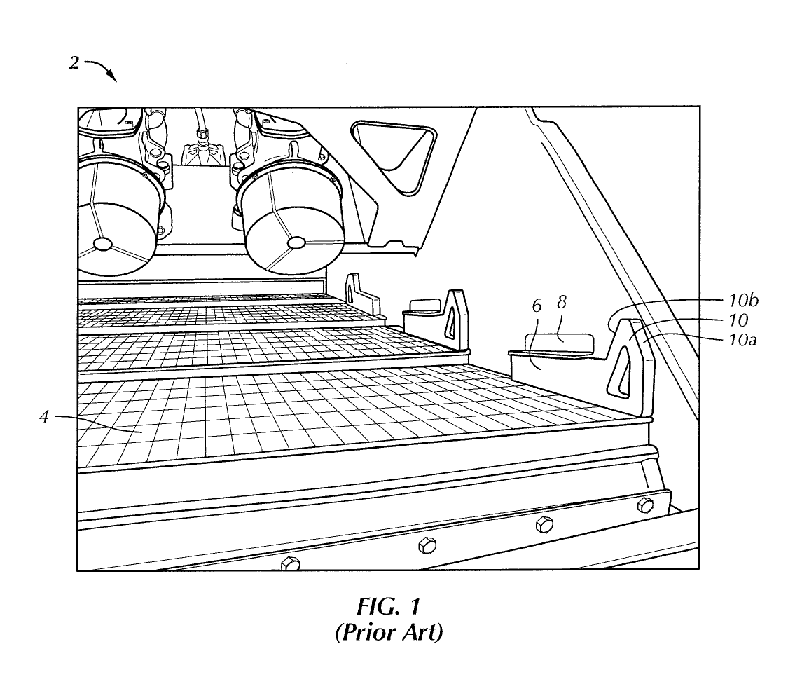

### DETAILED DESCRIPTION

In one aspect, embodiments disclosed herein relate to a screen frame assembly for an oilfield shale shaker. Specifically, embodiments disclosed herein relate to a shale shaker configured to engage a screen frame having wedge-like ends.

Embodiments of a screen frame assembly disclosed herein may not require bolts, clamps, or additional parts to hold a screen in place. Additionally, embodiments disclosed herein relate to a shaker apparatus that may include multiple screen frame assemblies that may be connected to one another. Multiple connected screen frame assemblies, in accordance with embodiments disclosed herein, may limit or reduce the time required to change or install screen frame assemblies in a shale shaker. Furthermore, embodiments disclosed herein relate to a shaker apparatus that may include multiple screen frame assemblies that have sloped ends. Sloped ends of multiple screen frame assemblies, in which the multiple screen frame assemblies may engage one another, may provide a clamping reaction force that may secure the multiple screen frame assemblies within a basket. Furthermore, sloped ends of multiple screen frame assemblies that extend in a direction that opposes a direction of material flow may reduce build-up of debris between engaging screen frame assemblies.

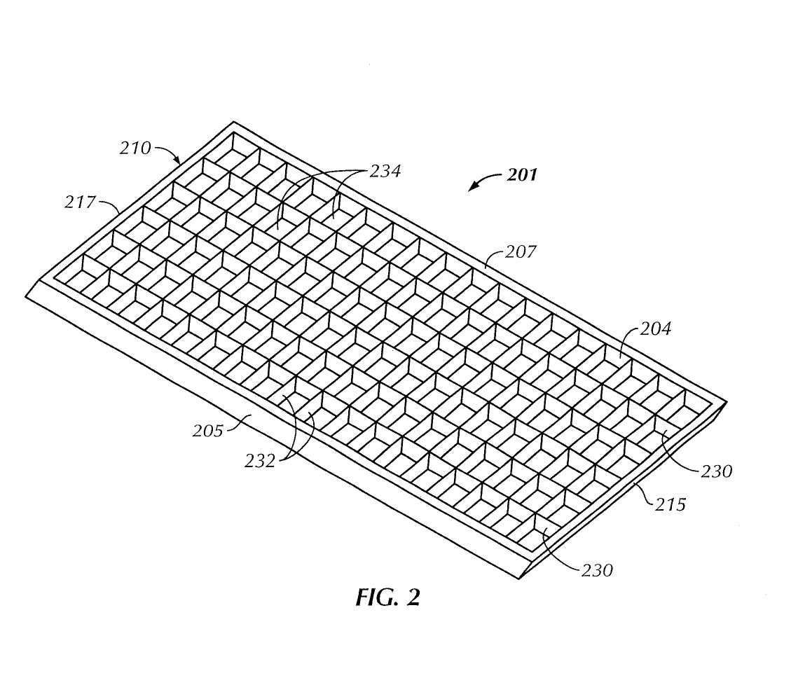

Referring initially to FIG. 2, a screen frame assembly 201 for an oilfield shaker in accordance with an embodiment of the present disclosure is shown. The screen frame assembly 201 includes a screen frame 204. Screen frame 204 has a first side 215 and a second side 217 extending between a first end 205 and a second end 207. At least one longitudinal cross-member 230 may extend between first end 205 and second end 207, disposed between first side 215 and second side 217. A plurality of transverse ribs 232 are arrayed between first end 205 and second end 207, intersecting with and supported by longitudinal cross-members 230, forming a plurality of perforations 234 between transverse ribs 232. A layer or more of mesh (not shown) may be placed on top surface 210 and may cover perforations 234 such that solid particles larger than a designated mesh size (not shown), in a slurry flowing across the screen disposed on screen frame 204, will not pass through the screen and the screen frame 204.

In one embodiment, screen frame 204 may be formed from any material known in the art, for example, stainless steel, metal alloys, plastics, etc. Screen frame 204 may also be formed from a composite material. In this embodiment, the composite material may include high-strength plastic and glass, reinforced with steel. Composite screen frames may provide more consistent manufacturing of the frame and may more evenly distribute mechanical stresses throughout the screen frame during operation. In one embodiment, screen frame 204 may include a composite material formed around a steel or wire frame. The screen frame 204 may be formed by injection molding. U.S. Pat. No. 6,759,000 discloses a method of forming a screen frame by injection molding and is herein incorporated by reference in its entirety. For example, in one embodiment, screen frame 204, having a wire frame and a composite or polymer material, may be formed by first placing a reinforcing wire frame assembly including at least a first end, a second end, a first side, a second side, and at least one cross-member in a mold tool. The mold tool may then be closed and liquid polymer may be injected into the mold tool by injection molding so as to wholly encapsulate the wire frame and to form an article having an open central region crisscrossed by transverse ribs bounded on each side by the screen frame 204. An inward force is then exerted on opposite faces of the wire frame assembly within the mold tool by fingers protruding inwardly from inside faces of the mold tool, the fingers being operable to engage the reinforcing wire frame when the mold tool closes. The fingers include inwardly projecting pegs which align with crossing points of wires to space the reinforcing wire frame from corresponding upper and lower internal surfaces of the mold tool and ensure that the reinforcing wire frame is buried within the polymer or composite material which is injected into the mold tool during the manufacturing process. The polymer or composite material is allowed to cure and then the screen frame 204 may be removed from the mold tool. Those having ordinary skill in the art will appreciate that injection molding is one of many ways a screen frame may be formed and that a screen frame in accordance with embodiments disclosed herein may be formed by any method known in the art.

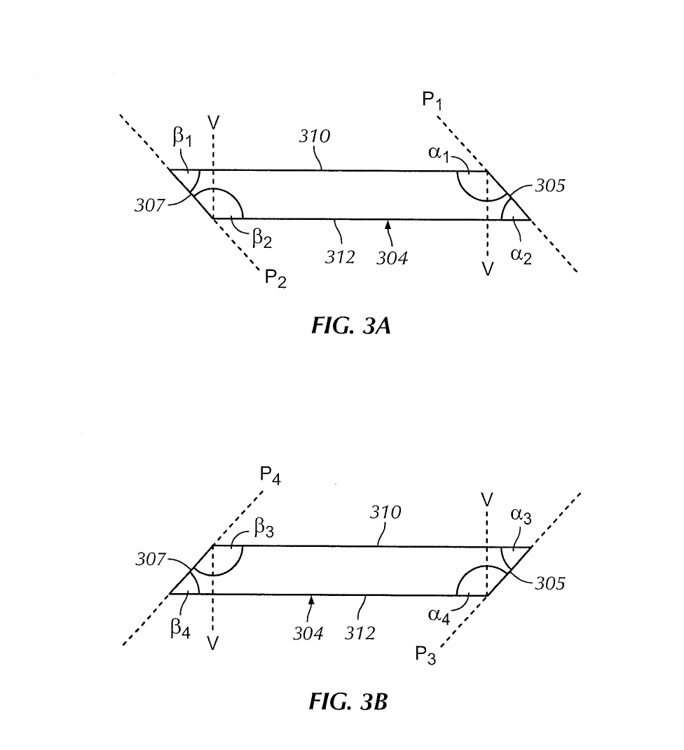

As shown in FIGS. 3-6, a screen frame in accordance with embodiments disclosed herein may have one or more angled or sloped ends. In one or more embodiments, the screen frame may include a first end and a second end that are not perpendicular to a top surface of the screen frame. In other embodiments, the screen frame may include a first end and a second end that are sloped, in which an angle formed between a top surface and at least one of the first end and the second end is one of an acute angle and an obtuse angle. In other words, the screen frame may include a first end and a second end that are sloped, in which the first end and the second end form at least one of a downward and an upward slope extending from a top surface. Thus, the screen frame may include a first end and a second end that are angled (i.e. not perpendicular to a top surface of the screen frame), in which the first end is parallel to the second end. In other embodiments, the first end of the screen frame may not be parallel to the second end of the screen frame. This may result in the first and second ends of the screen frame having wedge-like profiles, and the screen frame having the shape of a parallelogram or a rhomboid-like profile, as viewed from the side. The wedge-like ends may be used to wedge the screen into place without requiring additional parts, such as hammer wedges. Various embodiments of the screen frame assembly, where the screen frame includes a first end and a second end, in which at least one end is angled (i.e. not perpendicular to a top surface of the screen frame), are illustrated in FIGS. 3-6 and described below.

Referring generally to FIGS. 3A and 3B, a screen frame 304 according to embodiments disclosed herein is shown. In this embodiment, screen frame 304 may include a first end 305, a second end 307, a top surface 310, and a bottom surface 312. As described above, screen frame 304 may also include transverse ribs (not shown), longitudinal cross-members (not shown), and a plurality of perforations (not shown). As illustrated in FIGS. 3A and 3B, a direction that is perpendicular to the top surface 310 of the screen frame 304 is illustrated by vertical axes V. As shown, the top surface 310 is parallel to the bottom surface 312. Further, as shown, one or both of the first end 305 and the second end 307 of the screen frame 304 may extend in a direction that is not perpendicular to the top surface 310 of the screen frame 304 (i.e., in a direction that is not along vertical axes V). This may result in one or both of the first end 305 and second end 305 of the screen frame 304 having wedge-like profiles, and the screen frame 304 having the shape of a parallelogram or a rhomboid-like profile.

Referring to FIG. 3A, the first end 305 and the second end 307 extend along parallel axes P₁ and P₂, respectively. In other words, the first end 305 and the second end 307 are parallel. Neither the first end 305 nor the second end 307 of the screen frame 304 extend in the direction of the axes V (i.e., in a direction that is perpendicular to the top surface 310). Further, as shown in FIG. 3A, a plane (not shown) disposed along a surface of the first end (i.e., along the axis P₁) is parallel to a plane (not shown) disposed along a surface of the second end (i.e., along the axis P₂). An angle α₁ is formed between the top surface 310 and the first end 305 of the screen frame 304. Similarly, an angle β₁ is formed between the top surface 310 and the second end 307 of the screen frame 304. Further, an angle α₂ is formed between the bottom surface 312 and the first end 305 of the screen frame 304. Furthermore, an angle P₂ is formed between the bottom surface 312 and the second end 307 of the screen frame 304. As illustrated in FIG. 3A, the slope of the second end 307 of the screen frame 304 may be defined by the angle Pi. Because the first end 305 and the second end 307 are parallel (i.e., extend along parallel axes P₁ and P₂, respectively) and the top surface 310 and the bottom surface 312 are parallel, the angle α₂ is equal to the angle β₁. As such, the slope of the first end 305 of the screen frame 304 may also be defined by the angle β₁.

Referring to FIG. 3B, the first end 305 and the second end 307 are parallel. Neither the first end 305 nor the second end 307 of the screen frame 304 extend in the direction of the axes V (i.e., in a direction that is perpendicular to the top surface 310). An angle α₃ is formed between the top surface 310 and the first end 305 of the screen frame 304. Similarly, an angle β₃ is formed between the top surface 310 and the second end 307 of the screen frame 304. Further, an angle α₄ is formed between the bottom surface 312 and the first end 305 of the screen frame 304. Furthermore, an angle β₄ is formed between the bottom surface 312 and the second end 307 of the screen frame 304. As illustrated in FIG. 3A, the slope of the first end 305 of the screen frame 304 may be defined by the angle α₃. Because the first end 305 and the second end 307 are parallel (i.e., extend along parallel axes P₃ and P₄, respectively) and the top surface 310 and the bottom surface 312 are parallel, the angle β₄ is equal to the angle α₃. As such, the slope of the second end 307 of the screen frame 304 may also be defined by the angle α₃.

Referring to FIGS. 3A and 3B, the angle formed between the top surface 310 and the first end 305 of the screen frame 304 (i.e., angles α₁ and α₃) may be one of acute, right, and obtuse. Further, the angle formed between the top surface 310 and the second end 307 of the screen frame (i.e., angles β₁ and β₃) may be one of acute, right, and obtuse. For example, the slope of the first end 305 and the second end 307 of the screen frame 304, according to one or more embodiments of the present disclosure (e.g., defined by the angles α₂, α₃, β₁, and β₄) may be between 2 degrees and 178 degrees. In another embodiment, the slope of the first end 305 and the second end 307 of the screen frame 304 may be between 2 degrees and 45 degrees. In another embodiment, the slope of the first end 305 and the second end 307 of the screen frame 304 may be between 45 degrees and 120 degrees. In yet another embodiment, the slope of the first end 305 and the second end 307 of the screen frame 304 may be about 30 degrees. Further, because the first end 305 and the second end 307 of the screen frame 304 extend in a direction that is not perpendicular to the top surface 310 of the screen frame 304, the angles formed between the top surface 310 and the first end 305 of the screen frame 304 (i.e., angles α₁ and α₃) may be one of an acute angle and an obtuse angle. Similarly, the angles formed between the top surface 310 and the second end 307 of the screen frame 304 (i.e., angles β₁ and β₃) may be one of an acute angle and an obtuse angle. As such, first end 305 and the second end 307 may act as wedges, and may allow the screen frame 304 to self-clamp (i.e., engage) with corresponding wedge-shaped members (not shown) on a shale shaker (not shown), as discussed in more detail below.

As shown in FIGS. 3A and 3B, the first end 305 and the second end 307 are parallel (i.e., α₁ and β₁ are supplementary angles, α₃ and β₃ are supplementary angles), in which α₁, β₁, α₃, and β₃ are each one of acute, right, and obtuse. In other embodiments, the first end 305 and the second end 307 may not be parallel (i.e., α₁ and β₁ may not be supplementary angles, α₃ and β₃ may not be supplementary angles), in which α₁, β₁, α₃, and β₃ are each one of acute, right, and obtuse. In this case, α₂ may not be equal to β₁, and α₃ may not be equal to β₄. For example, the angle formed between one of the first end 305 and the second end 307 and the top surface 310 (e.g., α₁, β₁, α₃ and β₃) may be a right angle (i.e., one of the first end 305 and the second end 307 may extend in the direction of the axes V), while the angle formed between the other end and the top surface 310 may be one of an acute angle and an obtuse angle.

In other embodiments, the angle formed between the first end 305 and the top surface 310 (e.g., α₁ and α₃) may be equal to the angle formed between the second end 307 and the top surface 310 (e.g., β₁ and β₃), in which both angles are one of acute, right, and obtuse. In yet other embodiments, the angle formed between the first end 305 and the top surface 310 may not be equal to the angle formed between the second end 307 and the top surface 310, in which both angles are one of acute, right, and obtuse. In other words, in some embodiments, the screen frame 304 may have a rectangular or a trapezoid-like profile.

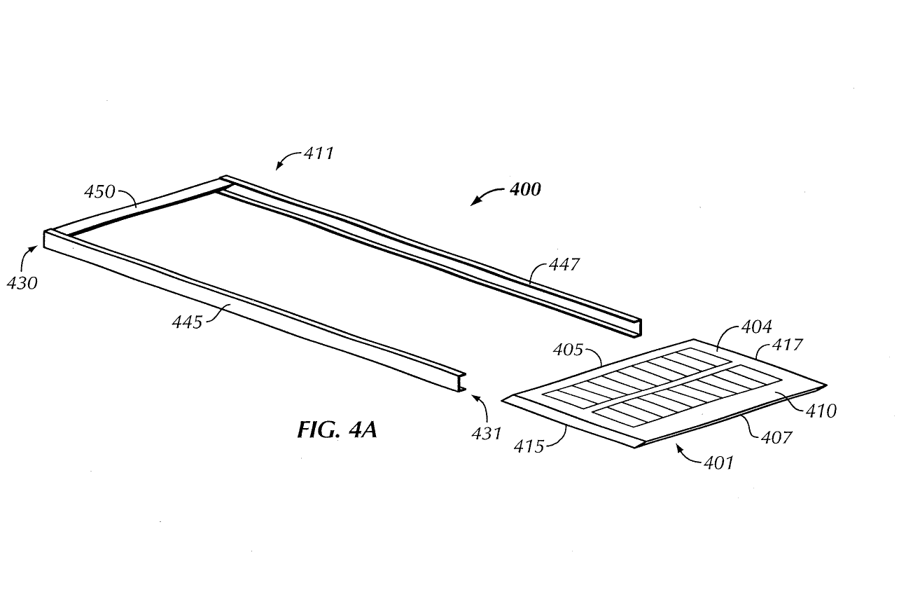

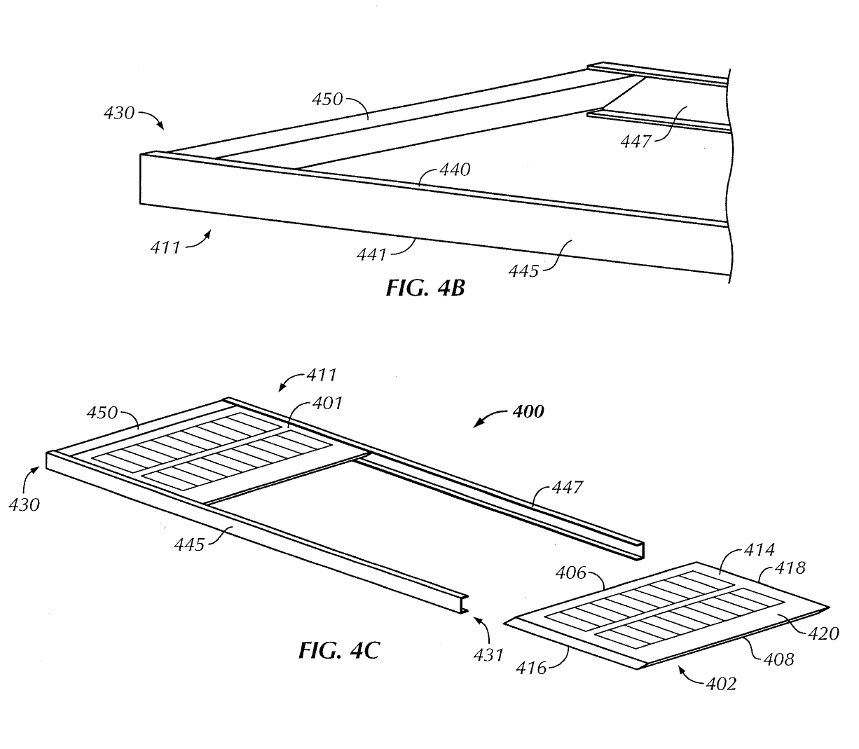

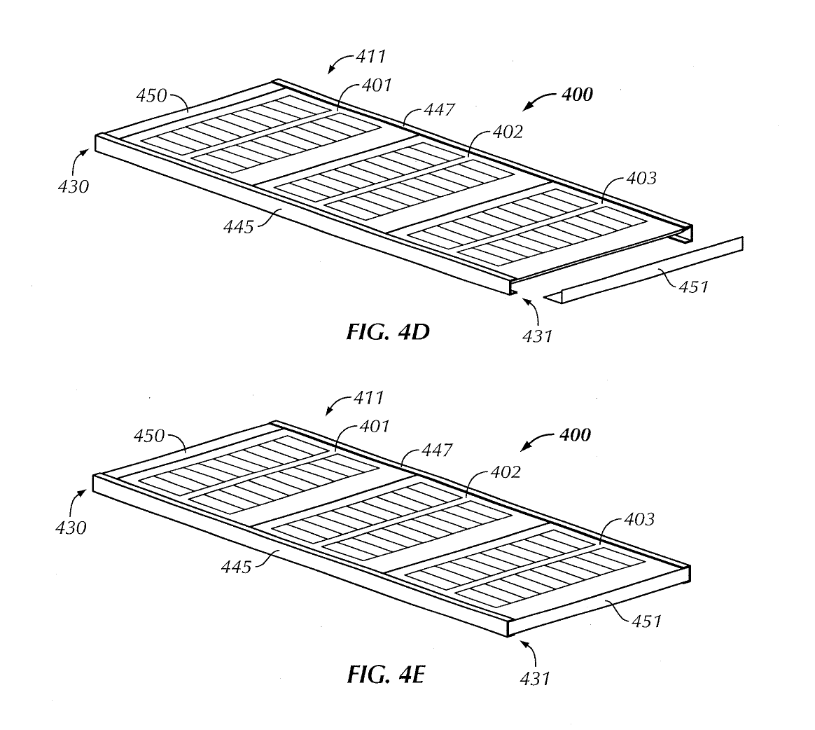

Referring now to FIGS. 4A-4E, a shaker apparatus in accordance with embodiments disclosed herein is shown. As illustrated in FIGS. 4A and 4B, a shaker apparatus (not shown) includes a basket (not shown) having a track system 411, and a first screen frame assembly 401. As shown, the track system 411 includes a feed end 430, a discharge end 431, a top surface 440, and a bottom surface 441. Further, as shown, the first screen frame assembly 401 includes a first frame 404 having a top surface 410, a first side 415 and a second side 417 extending between a first end 405 and a second end 407.

Referring to FIG. 4A, the first end 405 and the second end 407 of the first screen frame assembly 401 may be sloped, in which an angle formed between the top surface 410 and at least one of the first end 405 and the second end 407 of the first screen frame assembly 401 is one of an acute angle and an obtuse angle, as described above. Further, the first screen frame assembly 401 may be configured to be received within the track system 411. As shown in FIG. 4A, the track system 411 includes a first side track 445 and a second side track 447 extending between the feed end 430 and the discharge end 431 of the track system 411. The first side 415 and the second side 417 of the first screen frame assembly 401 may be configured to slide within the first side track 445 and the second side track 447 of the track system 411, respectively. Though the first side 415 and the second side 417 of the first screen frame assembly 401 may be configured to slide within the first side track 445 and the second side track 447 of the track system 411, respectively, those having ordinary skill in the art will appreciate that the first screen frame assembly 401 may be turned upside-down and received within the track system 411. For example, the first screen frame assembly 401 may be configured to slide within the second side track 447 and the first side track 445 of the basket, respectively. However, those having ordinary skill in the art will also appreciate that screen frame assemblies may not need to slide into a track system to be secured in a basket. For example, instead of using a track system, as described above, a basket may be configured to receive and secure screen frame assemblies such that the screen frame assemblies may be set into place without sliding.

As illustrated in FIGS. 4A and 4B, a first retainer wedge 450 is disposed on the feed end 430 of the track system 411 between the first track 445 and the second track 447. The sloped first end 405 of the first screen frame assembly 401 (discussed above in FIG. 4A) may be configured to engage with the first retainer wedge 450. For example, the slope of the first retainer wedge 450 may be such that the first retainer wedge 450 may engage with the first end 405 of the first screen frame assembly 401 (i.e., the slope of the first retainer wedge 450 may be substantially similar to the slope of the first end 405 of the first screen frame assembly 401). Further, as shown in FIG. 4A, the first retainer wedge 450 may be disposed on the feed end 430 of the track system 411 between the first track 445 and the second track 447 such that the sloped first end 405 of the first screen frame assembly 401 may engage with the first retainer wedge 450. Though the first retainer wedge 450 is shown disposed on the feed end of the track system 411, those having ordinary skill in the art will appreciate that the first retainer wedge 450 may be disposed at various locations along the track system 411. For example, the first retainer wedge 450 may be disposed on the downstream side 431 of the track system 411. The first retainer wedge 450 may be secured to each of the feed end 430 and the discharge end 431 of the track system 411 by one of, for example, threaded bolts, fasteners, clamps, and a pneumatic bladder. However, those having ordinary skill in the art will appreciate that the first retainer wedge 450 may be secured to various locations along the track system 411, including each of the feed end 430 and the discharge end 431, by any means known in the art. For example, the first retainer wedge 450 may be secured to the track system 411 by screws, a threaded rod, or any other securing means commonly known in the art. Further, the first retainer wedge 450 may be permanently attached to the track system 411 by being welded in place as a permanent part of the track system 411.

Referring now to FIG. 4C, a shaker apparatus having multiple screen frame assemblies in accordance with embodiments disclosed herein is shown. As shown, first screen frame assembly 401 is received within the first track 445 and the second track 447 of the track system 411. Further, as shown, the first end 405 of the first screen frame assembly 401 (discussed above in FIG. 4A) is engaged with the first retainer wedge 450, which is disposed on the feed end 430 of the track system 411. A second screen frame assembly 402 is shown and may also be received within the track system 411. The second screen frame assembly 402 may be substantially similar to the first screen frame assembly 401. As shown, second screen frame assembly 402 includes a second frame 414 having a top surface 420, and a first side 416 and a second side 418 extending between a first end 406 and a second end 408. As described above, second frame 414 may also include transverse ribs, longitudinal cross-members, and a plurality of perforations. A layer or more of mesh (not shown) may be placed on top surface 420 and may cover perforations (not shown) such that solid particles larger than a designated mesh size (not shown), in a slurry flowing across the screen disposed on the second frame 414, will not pass through the screen and the second frame 414. Each of the first end 406 and the second end 408 of the second screen frame assembly 402 may be sloped, in which an angle formed between the top surface 420 and at least one of the first end 406 and the second end 408 of the second screen frame assembly 402 is one of an acute angle and an obtuse angle, as described above. Further, the first side 416 and the second side 418 of the second screen frame assembly 402 may be configured to slide within the first side track 445 and the second side track 447 of the track system 411, as discussed above regarding the first screen frame assembly 401.

Still referring to FIG. 4C, the first end 406 of the second screen frame assembly 402 may be configured to engage with the second end 407 of the first screen frame assembly 401. As such, the slope of the first end 406 of the second screen frame assembly 402 may be such that the first end 406 of the second screen frame assembly 402 may engage with the second end 407 of the first screen frame assembly (i.e., the slope of the first end 406 of the second screen frame assembly 402 may be substantially similar to the slope of the second end 407 of the first screen frame assembly). However, those having ordinary skill in the art will appreciate that the first end 406 of the second screen frame assembly 402 may also be configured to engage with the first end 405 of the first screen frame assembly 401 and that this disclosure should not be limited to the configuration described above. Similarly, the second end 408 of the second screen frame assembly 402 may be configured to engage with any of the first end 405 and the second end 407 of the first screen frame assembly 401, as well as the first retainer wedge 450.

Referring now to FIG. 4D, a shaker apparatus having multiple screen frame assemblies and multiple retainer wedges in accordance with embodiments disclosed herein is shown. As shown, the first retainer wedge 450 is disposed on the feed end 430 of the track system 411 between the first track 445 and the second track 447 of the track system 411. Further, as shown, the first screen frame assembly 401 and the second screen frame assembly 402 are received within the track system 411. The first screen frame assembly 401 may be engaged with the track system 411 and the first retainer wedge 450, as described above in FIG. 4C. The second screen frame assembly 402 may be engaged with the track system 411 and the first screen frame assembly 401, as described above in FIG. 4C. Furthermore, a third screen frame assembly 403 is shown engaged with the track system 411 and the second screen frame assembly 402. The third screen frame assembly 403 may be substantially similar to the first screen frame assembly 401 and the second screen frame assembly 402 described above. Moreover, the third screen frame assembly 403 may engage with the track system 411 and the second screen frame assembly 402 in substantially the same way that the second screen frame assembly 402 may engage with the track system 411 and the first screen frame assembly 401.

As shown in FIG. 4D, a second retainer wedge 451 may be disposed on the downstream side 431 of the track system 411 between the first track 445 and the second track 447 of the track system 411. The second retainer wedge 451 may be substantially similar in structure and in composition to the first retainer wedge 450. As such, the first retainer wedge 450 and the second retainer wedge 451 may be interchangeable, and each of the first retainer wedge 450 and the second retainer wedge 451 may be disposed on each of the feed end 430 and the discharge end 431 of the track system 411. The third screen frame assembly 403 may engage with the second retainer wedge 451 in substantially the same way that the first screen frame assembly 401 may engage with the first retainer wedge 450. The second retainer wedge 451 may be secured to one of the feed end 430 and the discharge end 431 of the track system 411 in substantially the same way that the first retainer wedge 450 may be secured to the track system 411. For example, the second retainer wedge 451 may be secured to each of the feed end 430 and the discharge end 431 of the track system 411 by one of, for example, threaded bolts, fasteners, clamps, and a pneumatic bladder. However, those having ordinary skill in the art will appreciate that the second retainer wedge 451 may be secured to various locations along the track system 411, including each of the feed end 430 and the discharge end 431, by any means known in the art. For example, the second retainer wedge 451 may be secured to the track system 411 by screws, a threaded rod, or any other securing means commonly known in the art. Further, the second retainer wedge 451 may be permanently attached to the track system 411 by being welded in place as a permanent part of the track system 411, while the first retainer wedge 450 may be secured to the track system 411 by means described above, or vice versa.

Referring now to FIG. 4E, a shaker apparatus having multiple screen frame assemblies and multiple retainer wedges assembled in accordance with embodiments disclosed herein is shown. As shown, the first retainer wedge 450 is disposed on the feed end 430 of the track system 411 between the first track 445 and the second track 447 of the track system 411. Further, as shown, the first screen frame assembly 401, the second screen frame assembly 402, and the third screen frame assembly 403 are disposed within the track system 411, in which the first screen frame assembly 401 is engaged with the first retainer wedge 450. Finally, the second retainer wedge 451 is disposed on the downstream side 430 of the track system 411 between the first track 455 and the second track 447 of the track system 411, in which the third screen frame assembly 403 is engaged with the second retainer wedge 451. Although the shaker apparatus 400 shown in FIGS. 4A-4E include first, second, and third screen frame assemblies 401, 402, and 403, those having ordinary skill in the art will appreciate that the number of screen frame assemblies is not limited to these quantities. For example, a shaker apparatus may include one, two, three, four, or more screen frame assemblies in accordance with the present disclosure.

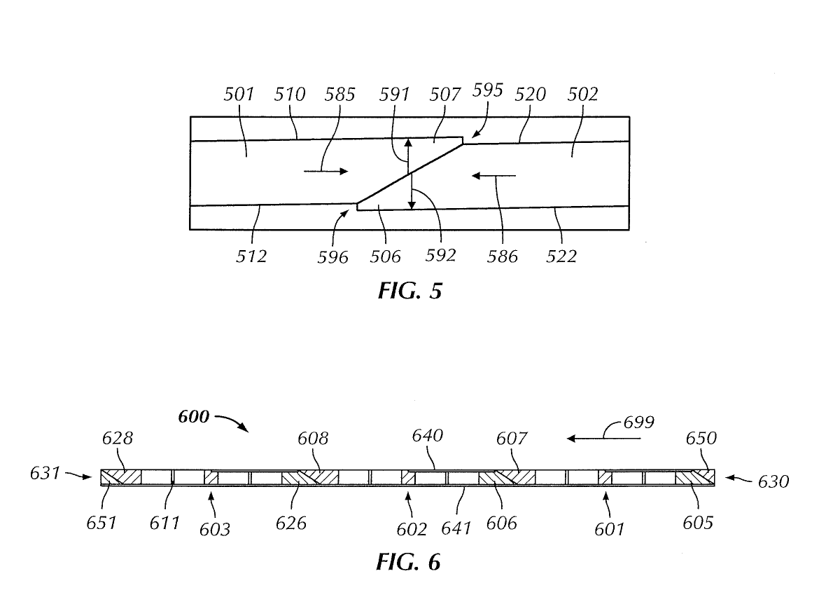

Referring now to FIG. 5, a side view of multiple screen frame assemblies according to embodiments disclosed herein is shown. As illustrated in FIG. 5, a first screen frame assembly 501 is engaged with a second screen frame assembly 502. Particularly, a second end 507 of the first screen frame assembly 501 is engaged with a first end 506 of the second screen frame assembly 502. The first screen frame assembly 501 may be forced toward the second screen frame assembly 502 by a first retainer wedge (not shown) in the direction of arrow 585. Similarly, the second screen frame assembly 502 may be forced toward the first screen frame assembly 501 by a second retainer wedge (not shown) in the direction of arrow 586. The second end 507 of the first screen frame assembly 501 and the first end 506 of the second screen frame assembly 502 may be sloped ends, as described above in FIGS. 4A-4E. As the first screen frame assembly 501 is drawn toward the second screen frame assembly 502, and vice versa, a vertical clamping reaction force, depicted by arrows 591 and 592, may result from the force caused by the retainer wedges and friction between the second end 507 of the first screen frame assembly 501 and the first end 506 of the second screen frame assembly 502. The vertical clamping reaction forces 591 and 592 may cause the first screen frame assembly 501 to rigidly clamp the second screen frame assembly 502 in place, and vice versa.

Still referring to FIG. 5, a top surface 510 of the first screen frame assembly 501 may not be flush with a top surface 520 of the second screen frame assembly 502 when the first screen frame assembly 501 is engaged with the second screen frame assembly 502. For example, as shown in FIG. 5, an offset 595 exists between the top surface 510 of the first screen frame assembly 501 and the top surface 520 of the second screen frame assembly 502 when the first screen frame assembly 501 is engaged with the second screen frame assembly 502. Similarly, as shown, an offset 596 exists between a bottom surface 512 of the first screen frame assembly 501 and a bottom surface 522 of the second screen frame assembly 502 when the when the first screen frame assembly 501 is engaged with the second screen frame assembly 502. The offsets 595 and 596 may prevent build-up of debris from occurring between the first screen frame assembly 501 and the second screen frame assembly 502. In alternate embodiments, top surface 510 and the bottom surface 512 of the first screen frame assembly 501 may be flush with the top surface 520 and the bottom surface 522 of the second screen frame assembly 502, respectively, such that there is no offset between the first screen frame assembly 501 and the second screen frame assembly 502.

Further, although not shown, the first screen frame assembly 501 may be connected to the second screen frame assembly 502 by a latching means (not shown). Specifically, the first screen frame assembly 501 may be connected to the second screen frame assembly 502 such that a force may displace the first screen frame assembly 501 in a direction that may cause the second screen frame assembly 502 to displace in the same direction. This may allow multiple screen frame assemblies (e.g., first screen frame assembly 501 and second screen frame assembly 502) to be removed from a basket (not shown) by only putting force on one of the screen frame assemblies. Those having ordinary skill in the art will appreciate that other connecting means known in the art may be used to connect multiple screen frame assemblies other than those described above.

Referring now to FIG. 6, a side view of a shaker apparatus in accordance with embodiments disclosed herein is shown. As shown in FIG. 6, a track system 611 has a top surface 640, a bottom surface 641, an feed end 630, and a discharge end 631. Further, as shown, a first retainer wedge 650 is disposed on the feed end 630 of the track system 611. A first screen frame assembly 601 is shown engaged with the first retainer wedge 650. Further, as shown, a second screen frame assembly 602 is engaged with the first screen frame assembly 601, and a third screen frame assembly 603 is engaged with the second screen frame assembly 602. Finally, a second retainer wedge 651 is disposed on the discharge end 631 of the track system 611 and is engaged with the third screen frame assembly 603. The engagement between each of the first screen frame assembly 601, the second screen frame assembly 602, the third screen frame assembly 603, the track system 611, the first retainer wedge 650, and the second retainer wedge 651 is described above, for example, regarding FIGS. 4A-4E.

Still referring to FIG. 6, each of the ends of each of the first screen frame assembly 601, the second screen frame assembly 602, and the third screen frame assembly 603 may be sloped ends. Specifically, the first end 605 and the second end 607 of the first screen frame assembly 601, the first end 606 and the second end 608 of the second screen frame assembly 602, and the first end 626 and the second end 628 of the third screen frame assembly 603, may be sloped ends. As shown in FIG. 6, the slope of the sloped ends of each of the first screen frame assembly 601, the second screen frame assembly 602, and the third screen frame assembly 603 extend from the top surface 640 of the track system 611 to the bottom surface 641 of the track system 611, toward the feed end 630 of the track system 611. As such, as material flows in the direction of arrow 699, the build-up of debris may be minimized in the spaces in which each of the first screen frame assembly 601, the second screen frame assembly 602, the third screen frame assembly 603, the first retainer wedge 650, and the second retainer wedge 651 engage.

For example, as shown in FIG. 6, the first end 606 of the second screen frame assembly 602 is engaged with the second end 607 of the first screen frame assembly 601. The slope of both the first end 606 of the second screen frame assembly 602 and the second end 607 of the first screen frame assembly 601 extend from the top surface 640 of the track system 611 to the bottom surface 641 of the track system 611, toward the feed end 630 of the basket. The material flow is in the direction of arrow 699, toward the discharge end 631 of the track system 611, in a direction that opposes the direction of the slope of the first end 606 and the second end 607 of the second screen frame assembly 602 and the first screen frame assembly 601, respectively. Because the direction of the slope of the first end 606 and the second end 607 of the second screen frame assembly 602 and the first screen frame assembly 601, respectively, opposes the direction of the material flow, the amount of build-up of debris between the first screen frame assembly 601 and the second screen frame assembly 602 may be minimized. However, those having ordinary skill in the art will appreciate that the slope of the ends of engaging screen frame assemblies and retainer wedges is not required to oppose the direction of material flow. For example, the slope of the sloped ends of each of the first screen frame assembly 601, the second screen frame assembly 602, and the third screen frame assembly 603 may extend from the top surface 640 of the track system 611 to the bottom surface 641 of the track system 611, toward the discharge end 631 of the track system 611.

A method of assembling a shaker apparatus, in accordance with embodiments disclosed herein, may include providing a basket having a feed end, a discharge end, and two side tracks, inserting a first screen frame assembly into the two side tracks of the basket, inserting a second screen frame assembly into the two side tracks of the basket, and engaging sloped ends of each of the first screen frame assembly and the second screen frame assembly. The first screen frame assembly may include a first end, a second end, a top surface, a first side disposed between the first end and the second end, and a second side disposed opposite the first side and disposed between the first end and the second end. At least one of the first end and the second end of the first screen assembly may be sloped. The second screen frame assembly may include a first end, a second end, a top surface, a first side disposed between the first end and the second end, and a second side disposed opposite the first side and disposed between the first end and the second end. At least one of the first end and the second end of the second screen frame assembly may be sloped.

The method may also include providing at least one retainer wedge and securing the at least one retainer wedge to at least one of the feed end and the discharge end of the basket. The at least one retainer wedge may be secured to at least one of the feed end and the discharge end of the basket by one of, for example, threaded bolts, fasteners, clamps, and a pneumatic bladder, as discussed above. Further, securing the at least one retainer wedge to at least one of the feed end and the discharge end of the basket may include securing the at least one retainer wedge such that the sloped face of the at least one retainer wedge engages with one of the sloped ends of one of the first screen frame assembly and the second screen frame assembly. Finally, the method may include connecting the first screen frame assembly to the second screen frame assembly, as described above.

While embodiments have been described with respect to a limited number of embodiments, those skilled in the art, having benefit of this disclosure, will appreciate that other embodiments can be devised which do not depart from the scope of embodiments disclosed herein. Accordingly, the scope of embodiments disclosed herein should be limited only by the attached claims.

What is claimed is:

1. A screen frame assembly, comprising:
a frame comprising:
a first end;
a second end;
a top surface;
a first side disposed between the first end and the second end; and
a second side disposed opposite the first side and disposed between the first end and the second end,
wherein at least one of the first end and the second end is sloped.

2. The screen frame assembly of claim 1, wherein an angle formed between the top surface and at least one of the first end and the second end is one of an acute angle and an obtuse angle.

3. The screen frame assembly of claim 1, wherein the screen frame assembly comprises a layer of screen mesh mounted on the screen frame.

4. The screen frame assembly of claim 1, wherein the first end is parallel to the second end.

5. A shaker apparatus, comprising:
a basket having a feed end and a discharge end; and
a first screen frame assembly, comprising:
a first frame comprising:
a first end;
a second end;
a top surface;
a bottom surface;
a first side disposed between the first end and the second end; and
a second side disposed opposite the first side and disposed between the first end and the second end,
wherein at least one of the first end and the second end is sloped.

6. The shaker apparatus of claim 5, wherein an angle formed between the top surface and at least one of the first end and the second end is one of an acute angle and an obtuse angle.

7. The shaker apparatus of claim 5, wherein the first screen frame assembly comprises a layer of screen mesh mounted on the first frame.

8. The shaker apparatus of claim 5, wherein the first end of the first screen frame assembly is disposed proximate the feed end of the basket and the second end of the first screen frame assembly is disposed proximate the discharge end of the basket.

9. The screen frame assembly of claim 5, wherein the first end of the first screen frame assembly is parallel to the second end of the first screen frame assembly.

10. The shaker apparatus of claim 5, wherein the basket further comprises a first and a second side track, wherein the first and the second sides of the first screen frame assembly are configured to slide within the first and the second side tracks of the basket.

11. The shaker apparatus of claim 5, wherein a slope of the sloped ends of the first screen frame assembly extends from the top surface of the first frame to the bottom surface of the first frame, toward the feed end of the basket.

12. The shaker apparatus of claim 5, further comprising at least one retainer wedge, wherein the at least one retainer wedge comprises a sloped face configured to engage with one of the sloped ends of the first screen frame assembly.

13. The shaker apparatus of claim 12, wherein the at least one retainer wedge is disposed on at least one of the feed end and the discharge end of the basket.

14. The shaker apparatus of claim 12, wherein the at least one retainer wedge is secured to one of the feed end and the discharge end of the basket by one of a group consisting of threaded bolts, fasteners, clamps, welds, and a pneumatic bladder.

15. The shaker apparatus of claim 5, further comprising a second screen frame assembly, wherein the second screen frame assembly comprises:
a second frame comprising:
a first end;
a second end;
a top surface;
a first side disposed between the first end and the second end; and
a second side disposed opposite the first side and disposed between the first end and the second end,
wherein at least one of the first end and the second end is sloped,

16. The shaker apparatus of claim 15, wherein an angle formed between the top surface and at least one of the first end and the second end is one of an acute angle and an obtuse angle.

17. The shaker apparatus of claim 15, wherein the at least one sloped end of the first screen frame assembly is configured to engage with the at least one sloped end of the second screen frame assembly.

18. The shaker apparatus of claim 15, wherein the first screen frame assembly is configured to attach to the second screen frame assembly.

19. A method of assembling a shaker apparatus, comprising:
providing a basket having a feed end, a discharge end, and two side tracks;
inserting a first screen frame assembly into the two side tracks of the basket, the first screen frame assembly having a first end, a second end, a top surface, a first side disposed between the first end and the second end, and a second side disposed opposite the first side and disposed between the first end and the second end, wherein at least one of the first end and the second end is sloped;
inserting a second screen frame assembly into the two side tracks of the basket, the second screen frame assembly having a first end, a second end, a top surface, a first side disposed between the first end and the second end, and a second side disposed opposite the first side and disposed between the first end and the second end,
wherein at least one of the first end and the second end is sloped; and
engaging the sloped ends of each of the first screen frame assembly and the second screen frame assembly.

20. The method of claim 19, further comprising:
providing at least one retainer wedge; and
securing the at least one retainer wedge to at least one of the feed end and the discharge end of the basket.

21. The method of claim 20, wherein securing the at least one retainer wedge to at least one of the feed end and the discharge end of the basket comprises securing the at least one retainer wedge such that the sloped face of the at least one retainer wedge engages with one of the sloped ends of one of the first screen frame assembly and the second screen frame assembly.

22. The method of claim 20, wherein the at least one retainer wedge is secured to the basket by one of a group consisting of threaded bolts, fasteners, clamps, welds, and a pneumatic bladder.

23. The method of claim 19, wherein a slope of the sloped ends of the first screen frame assembly extends from the top surface of the first frame to the bottom surface of the first frame, toward the feed end of the basket.

24. The method of claim 19, wherein a slope of the sloped ends of the second screen frame assembly extends from the top surface of the second frame to the bottom surface of the second frame, toward the feed end of the basket.

25. The method of claim 19, further comprising connecting the first screen frame assembly to the second screen frame assembly.
